(19) United States
(12) Patent Application Publication
(10) Pub. No.: US 2003/0204407 A1
(43) Pub. Date: Oct. 30, 2003

(54) System and apparatus for tracking, monitoring, and reporting parameter of a mobile unit

(76) Inventors: John Nabors, Marcy, NY (US); Randy Caldwell, Clinton, NY (US); Alan Copeland, Oriskany, NY (US); Fred Matrulli, Utica, NY (US)

Correspondence Address: HANCOCK & ESTABROOK, LLP, 1500 MONY Tower I, PO Box 4976, Syracuse, NY, 13221-4976, US

(21) Appl. No.: 10/134,350

(22) Filed: Apr. 26, 2002

(51) Int. Cl. G06F 17/60

(52) U.S. Cl. 705/1

(57) ABSTRACT

The present invention provides an information management system that permits remote monitoring and reporting of predetermined parameters of a mobile unit, such as a cargo container that is adapted to transport goods from one location to another and be pulled behind a tractor and carried on a chassis. The system generally includes a circuit module interconnected to a mobile unit and that contains the circuitry and hardware to facilitate the monitoring of predetermined parameters associated with the unit; a host computer to which the circuit module transmits information at predetermined intervals; and a plurality of remote computers that may remotely access data associated with a predetermined unit or fleet of mobile units from the host computer via the world wide web, or an equivalent type of networked environment.

### BACKGROUND OF THE INVENTION

1. Field of Invention

The present invention relates generally to information management systems, and more particularly to such systems for tracking mobile units, such as a tractor chassis, cargo container, and the like, and that further permit remote monitoring and reporting of predetermined parameters of the mobile unit.

2. Prior Art

Mobile units, such as cargo containers and the chassis on which they are placed, that are used by shipping companies to transport goods from one location to another can often be lost in a remote as a result of it being detached from the chassis (tractor) behind which they are pulled. A company having a fleet of such units may not know the location of many or any of the units in the fleet at any given time, thereby causing an inefficient use and allocation of these resources. In addition, there is currently no known system that permits a company to know at all times which of its mobile units have been actively transporting goods, which units have been stagnant, for how long each has been stagnant, and from where to where each unit is traveling, among other parameters. Thus, no currently existing system permits optimal management and utilization of a fleet of mobile units.

Global positioning systems and other satellite navigation tools are well known. Use of such devices to pinpoint the precise location of an object to which the device is attached, and to provide directions to a desired location is a useful tool. However, such GPS type systems do not permit remote monitoring and reporting of parameters associated with the units to which they are attached.

3. Objects and Advantages

It is therefore a principal object and advantage of the present invention to provide a system and method for remotely monitoring predetermined parameters of a mobile unit.

It is another object and advantage of the present invention to provide a system for providing a networked, computerized reporting protocol for predetermined parameters associated with a mobile unit or fleet of mobile units.

It is a further object and advantage of the present invention to provide a system that permits optimal management and asset allocation for a fleet of mobile units.

It is an additional object and advantage of the present invention to provide a system that may be integrated into existing computer architecture platforms.

Other objects and advantages of the present invention will in part be obvious, and in part appear hereinafter.

### SUMMARY OF THE INVENTION

In accordance with the foregoing objects and advantages, the present invention provides an information management system that permits remote monitoring and reporting of predetermined parameters of a mobile unit, such as a cargo container and chassis that is adapted to transport goods from one location to another and be pulled behind a tractor. The system generally comprises a circuit module interconnected to a mobile unit and that contains the circuitry and hardware to facilitate the monitoring of predetermined parameters associated with the unit; a host computer to which the circuit module transmits information at predetermined intervals; and a plurality of remote computers that may remotely access data associated with a predetermined unit or fleet of mobile units from the host computer via the world wide web, or an equivalent type of networked environment.

The circuit module includes a microprocessor with static and flash memory, and control circuitry incorporated therein. The microprocessor receives communications regarding various parameters associated with the mobile unit, such as the motion status of the tractor to which it is interconnected, the brake status of the tractor, the voltage level of the microprocessor's power source, whether a container is attached to (covering) a chassis, whether the chassis is attached to a tractor, and identifying data regarding the container and tractor. All of this data is communicated to the microprocessor and stored in the memory. The microprocessor also includes a port that requests positional data from a global positioning system (GPS) at predetermined intervals, which data is also stored in memory, and a link to a cellular modem, or other wireless transmission mechanism, for transmitting the collected data/parameters to the host computer.

As indicated, a GPS antenna and receiver assembly attached to the mobile unit and interconnected to the microprocessor receives positional data of the mobile unit at regular intervals, and as previously indicated, provides this information to the microprocessor. The cellular modem and antenna (i.e., cellular transceiver) requests and receives data stored in the memory of the microprocessor and transmits it through a cellular network that ultimately routes the data to the host computer at predetermined intervals.

The host computer receives the data for a particular mobile unit and places that data in various tables contained within a database. The database may then be accessed at remote terminals by the owner of the mobile unit/fleet of mobile units via a networked environment, such as the world wide web, or other networked environment. When the owner of the unit(s) logs on to the database and provides the required password (or accesses it in a similar, secure manner), the database only makes data accessible that relate to the mobile units owned by that party. The user may then generate reports of the parameters associated with the mobile unit(s). The database permits various reports for a particular mobile unit or fleet of mobile units to be generated at the remote computers.

### BRIEF DESCRIPTION OF THE DRAWINGS

The present invention will more fully understood and appreciated by reading the following Detailed Description in conjunction with the accompanying drawings, in which:

FIG. 1 is a block diagram of the overall system environment of the present invention;

FIG. 2 is a block diagram/schematic representation of the mobile unit and circuit module of the present invention;

FIG. 3 is a block diagram of a circuit module;

FIG. 4 is a data flow chart of the present invention;

FIGS. 5a, 5b, 5c, 5d, and 5e are sample reports displayed on a screen for a remote computer accessing the database on the host computer; and

FIGS. 6a and 6b are representative mapping report displays.

### DETAILED DESCRIPTION

Referring now to the drawings, wherein like reference numerals refer to like parts throughout, there is seen in FIG. 1 an information management system, designated generally by reference numeral 10, for use in conjunction with a mobile unit, such as a cargo container 12 that is mounted on a chassis 14 which is towed by a tractor 16. Information management system 10 generally comprises a circuit module assembly 100 mounted on either container 12 (or on a generator attached to container 12) or chassis 14 (the term “mobile unit” refers to either container 12 or chassis 14) and which wirelessly transmits data regarding container 12 through a cellular network 200 to a host computer system 300 that, in turn, males the data accessible by a plurality of remote computers 400.

The circuit module assembly 100 generally comprises a microprocessor 102, such as a Rabbit 2000 manufactured by Rabbit Semiconductor of Davis, Calif., that includes a memory 104, such as a static RAM and flash memory, and control circuitry 106 for controlling the flow of data into and out of module 100. Circuit module assembly 100 further comprises a variety of condition sensors all electrically attached to microprocessor 102. The variety of sensors include, for example, a battery voltage level sensor 108, a mobile unit motion sensor 109, such as mercury switch, a brake sensor 110, such as one that monitors power sent to the brake lights, a communications link 111 for providing microprocessor 102 with electronic identification data (i.e., a VIN number) about tractor 16, a sensor 112 to determine whether container 12 is attached to chassis 14 (there may be two of these sensors as there may be two containers mounted on the same trailer), and ultrasonic alarms 114, 116, associated with sensor 112 for sounding an alarm if container 12 (and a second container—not shown) becomes detached from chassis 14. Other sensors may also be included in the present system, such as sensors for determining chassis location, chassis speed, chassis direction, container security tag secure or breached, container electronic ID number and tag number. A global positioning system (GPS) comprising receiver 118 and antenna 120 are also electrically connected to microprocessor 102 for providing positional data of container 12 to microprocessor 102 when requested to do so. A cellular modem 122 and antenna 124 are electrically connected to microprocessor 102 for wirelessly transmitting the GPS positional data, and the data gathered from the various sensors. A battery charger 126 and power source 128, such as a 12 VDC battery, are also electrically interconnected to microprocessor 102. To ensure that microprocessor 102 will always have sufficient power, battery charging device 126 receives a charge from the tractor's power source through a conventional connection, such as a J560 connector 130. If the battery 128 is running low, a signal is sent from microprocessor 102 to turn off all draining sources drawing therefrom in order to permit microprocessor to have enough power left to receive and transmit one signal indicating its current location.

Cellular modem 122 is assigned a unique electronic serial number (ESN), such that each cellular modem that is mounted on a mobile unit 12 will have its own unique ESN. Likewise, each chassis 14 will have a unique identification number (ID). Thus, when a cellular modem 122 is installed on a chassis 14, a data entry person can match the chassis' ID number and the cellular modem's ESN in the database.

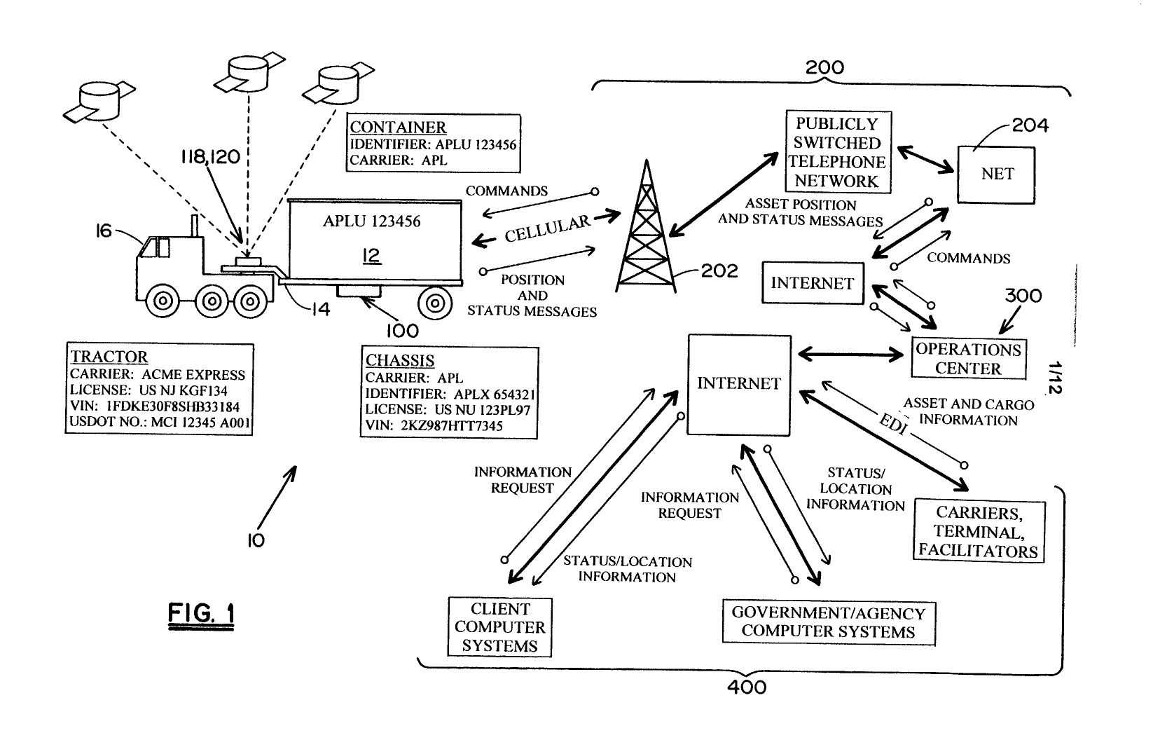

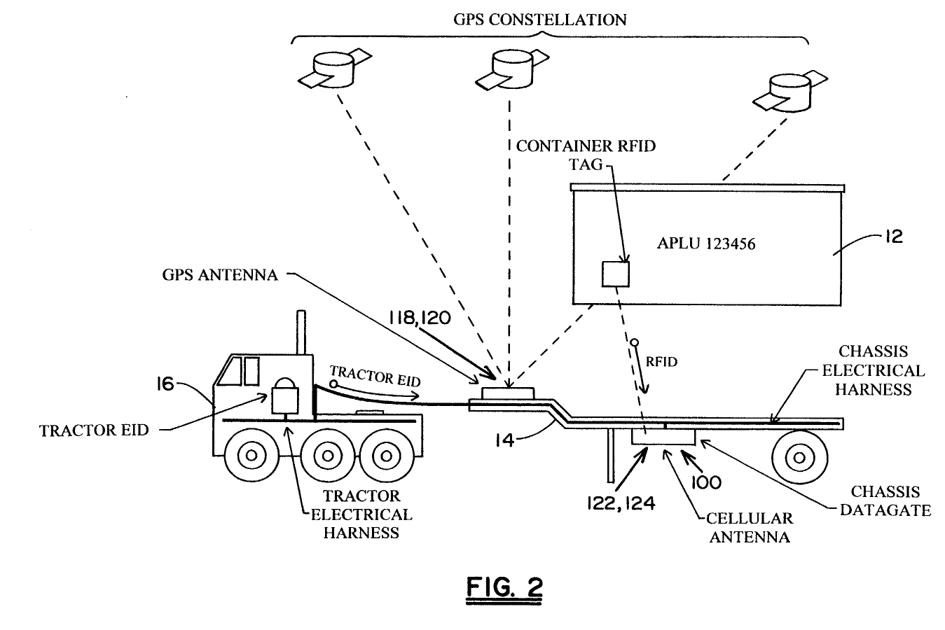

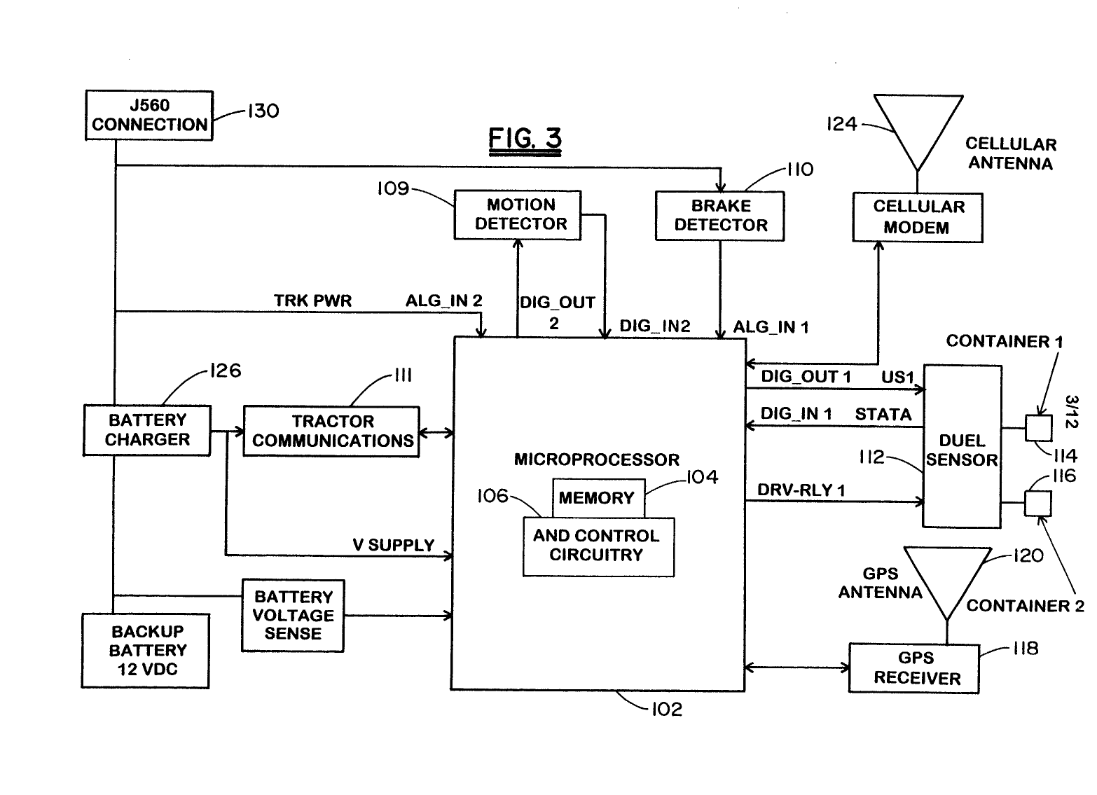

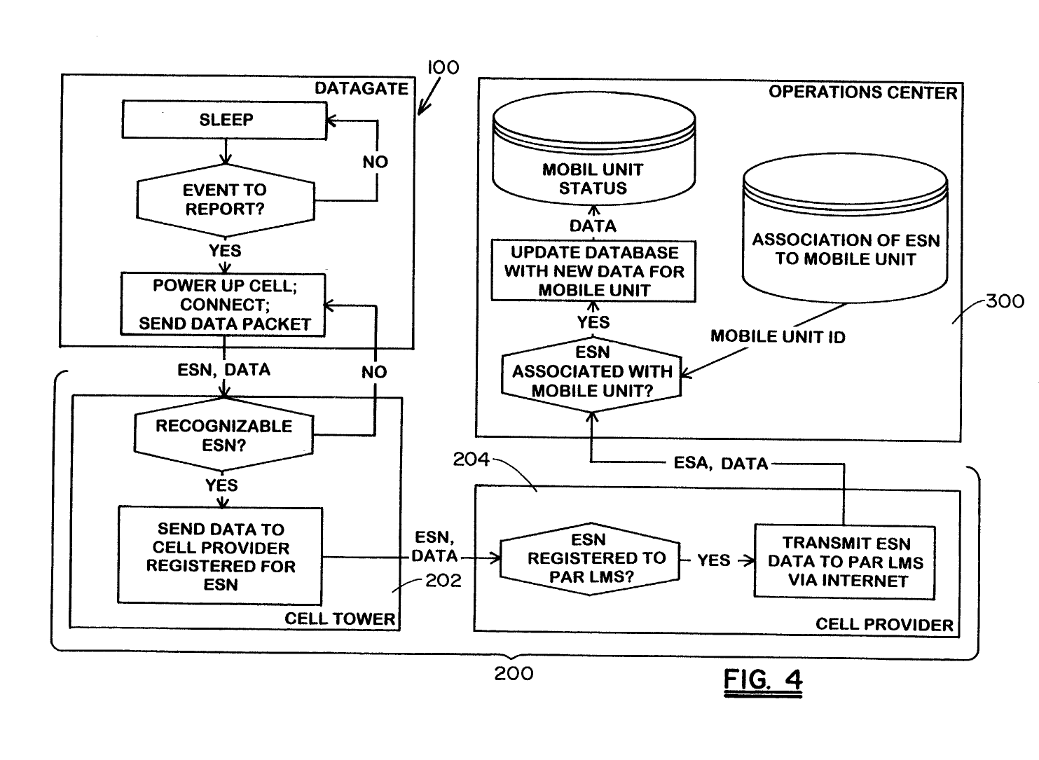

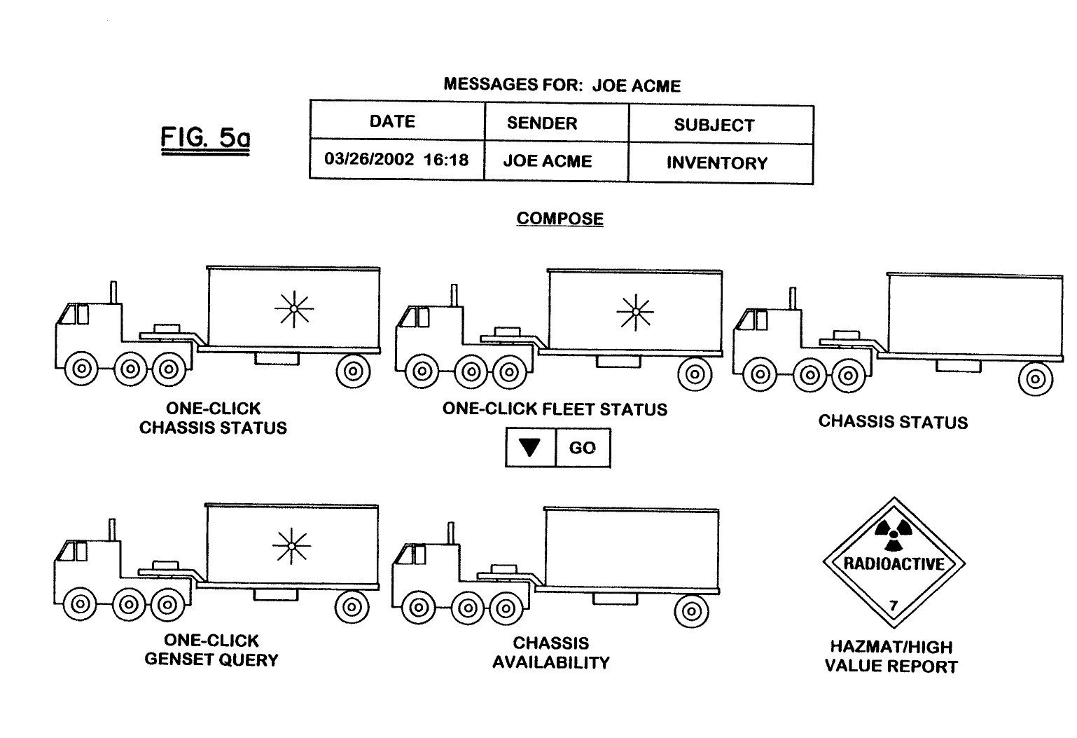

Referring to FIG. 4, each time cellular modem 122 transmits data (i.e., it has an event to report) to a cellular network 200, the first piece of data transmitted is the ESN. When a cell tower 202 receives the transmission, it routes the data to the cellular service provider 204 associated with the ESN (if the cell tower cannot match the ESN with any cellular provider, it does not transmit the data anywhere). The cellular service provider 204 reads the ESN, and determines where to route the data. Once the cellular service provider 204 determines with whom the ESN is associated (i.e., the host computer 300), it transmits the data to host computer 300, via the Internet or some other digital data communications network. Once host computer 300 receives the data from cellular service provider 204, it matches/associates the data to the chassis 14 with the ID number from the particular cellular modem installed thereon, and updates the appropriate tables in the database with the new data.

Host computer 300 maintains a series of tables in a database. The tables organize the database such that the predetermined data parameters associated with the mobile unit are accessible to remote computers 400 via the Internet or other networked computer environment. A user can query the database in order to locate particular parameters associated with one of its chasses. The database is protected by passwords or some other security measure so that only the owner of a particular mobile unit/fleet of mobile units (or other authorized party) can access the database. Based on the user's password or other secured entry mechanism, the database only makes data associated with the mobile units owned by that particular user available for inspection.

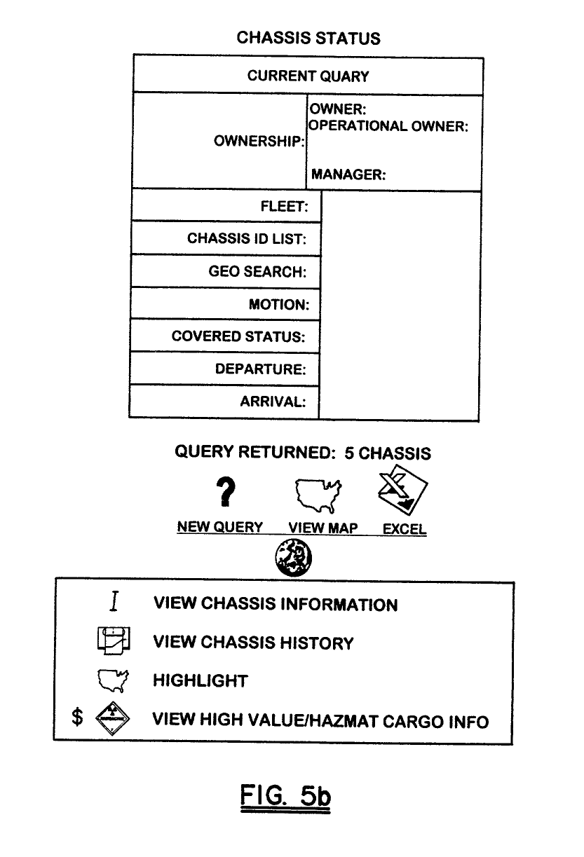

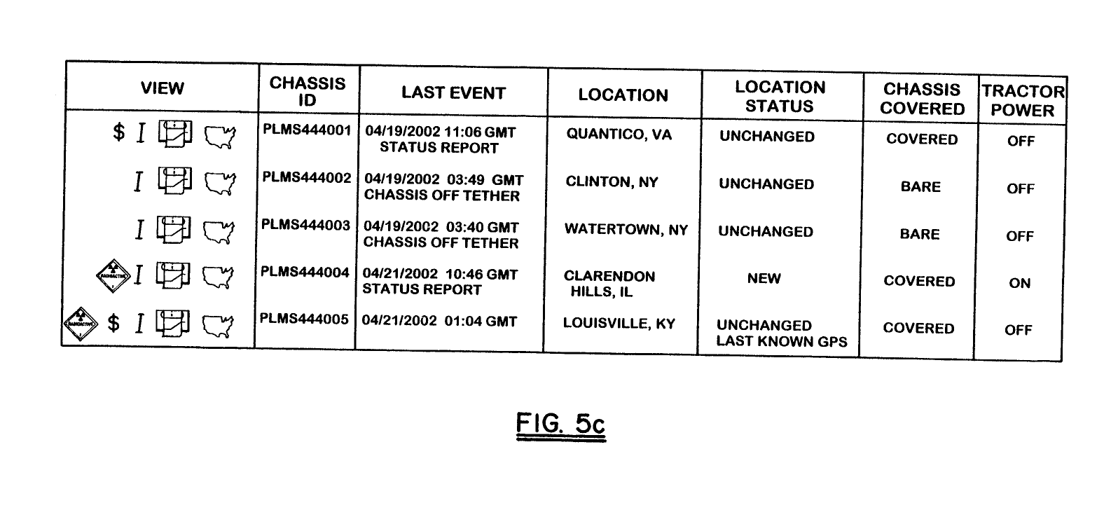

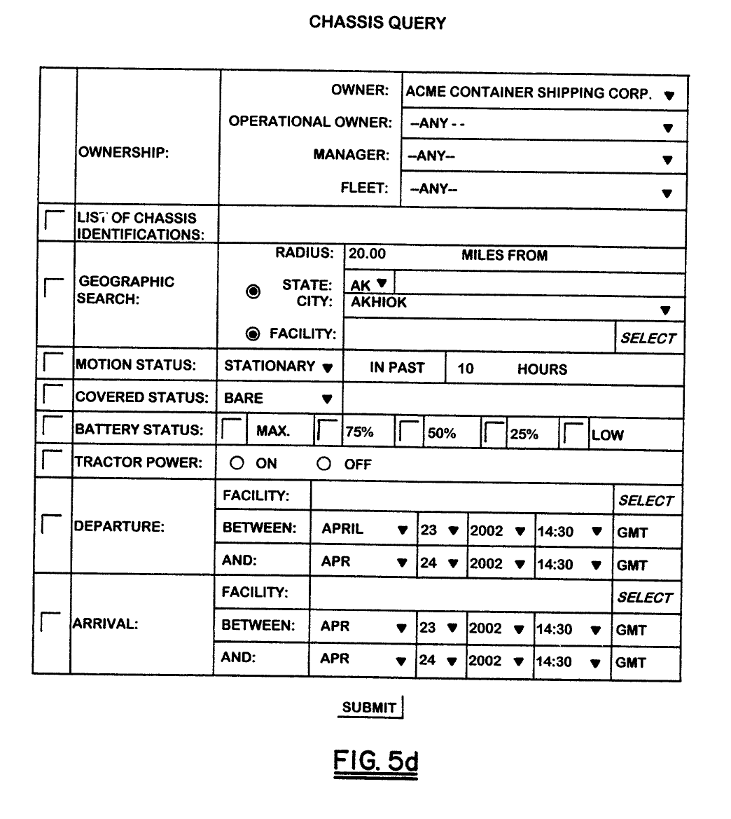

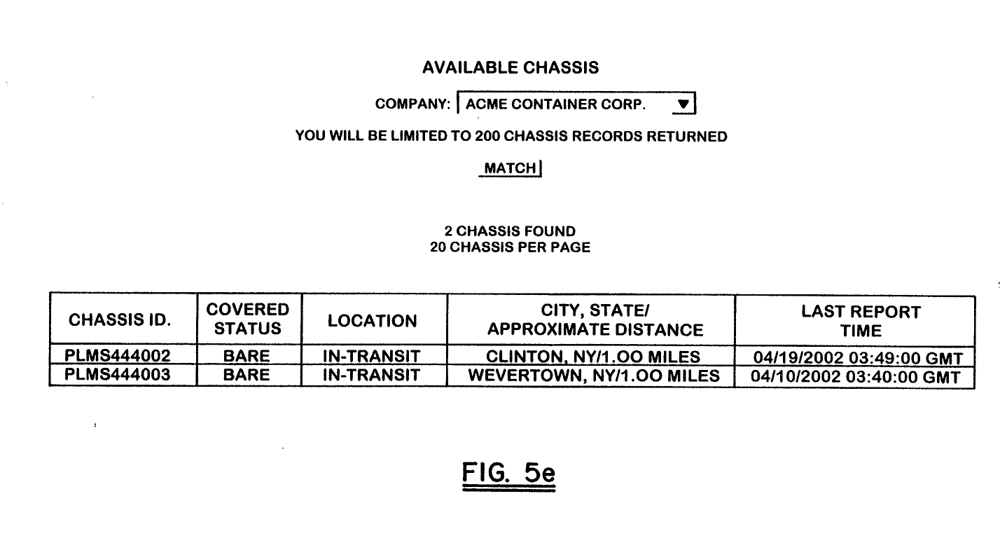

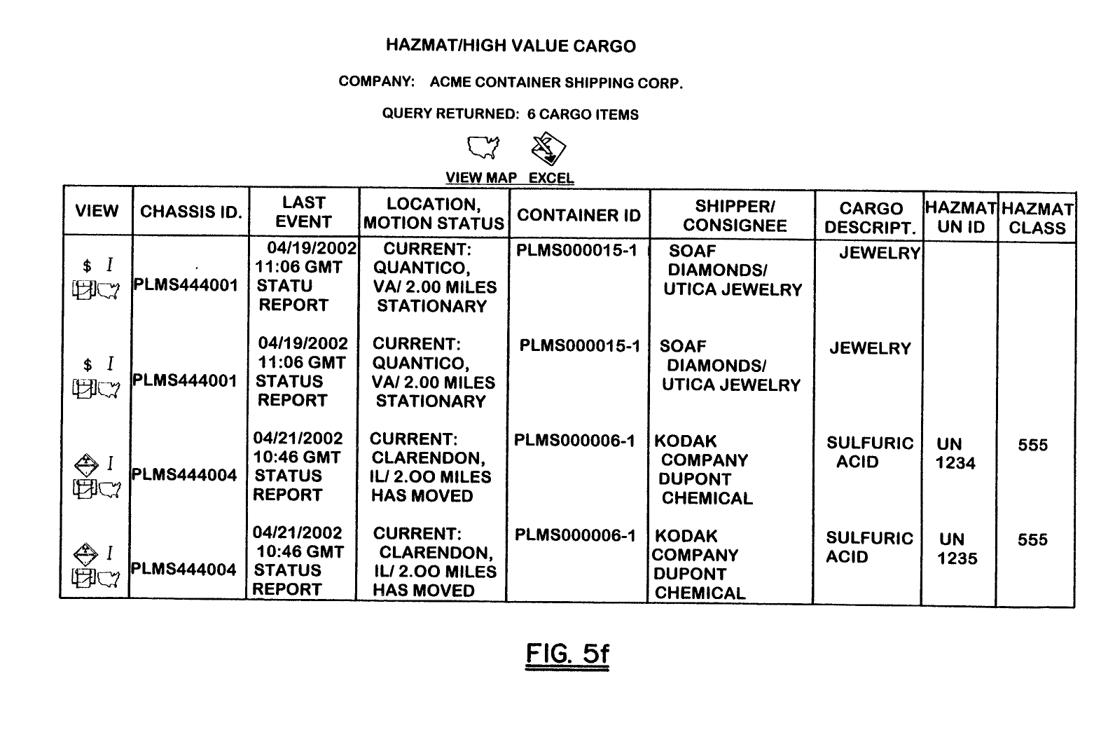

Once a remote computer 400 accesses host computer 300, the user can query the database to display desired parameters associated with the mobile units. For instance, a user can query and display a table, such as those illustrated in FIGS. 5a-5c.

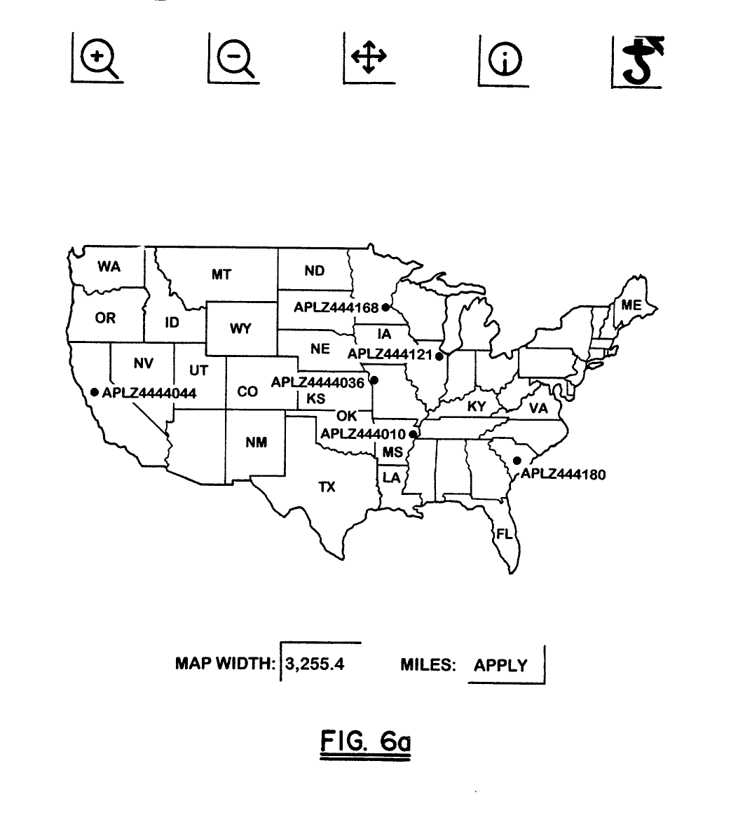

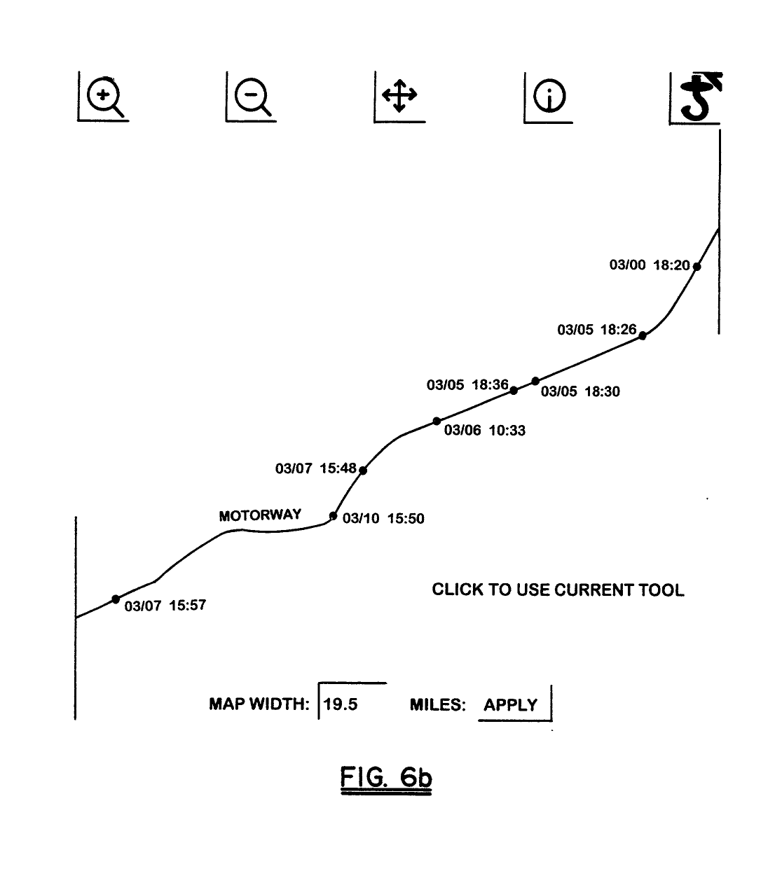

Host computer 300 also supports a suite of mapping software, such as MapXtreme Java from MapInfo Corporation, Troy, N.Y. This software has been integrated with the mobile unit database tables, to provide visual geographic display of current mobile unit location information, as illustrated in FIG. 6a. In addition, the mapping software can be used to display historical data, such as the route mobile unit 12 has traveled, or is traveling, as illustrated in FIG. 6b. The mapping software can be manipulated by increasing or decreasing the mileage scale displayed using a “zoom in-zoom out” function, and in other ways that are typical of mapping programs.

What is claimed is:

1. A system for remotely monitoring predetermined parameters of a mobile unit and reporting said predetermined parameters to a host computer, said system comprising:
a. predetermined parameter determining means interconnected to said mobile unit;
b. transmitting means associated with said predetermined parameter determining means;
c. actuating means associated with said transmitting means to cause said predetermined parameter to eventually be transmitted to said host computer at predetermined intervals;
d. a remote computer interconnected to said host computer; and
e. means for said remote computer to access said predetermined parameters on said host computer.

2. The system according to claim 1, wherein said transmitting means comprises a cellular receiver and antenna.

3. The system according to claim 2, wherein said transmitting means further comprises a cellular tower capable of receiving and transmitting said predetermined parameters.

4. The system according to claim 1, wherein said predetermined parameter determining means comprises a global positioning receiver and antenna.

5. The system according to claim 1, wherein said predetermined parameter determining means comprises a brake sensor.

6. The system according to claim 1, wherein said predetermined parameter determining means comprises a tether sensor.

7. The system according to claim 1, wherein said predetermined parameter determining means comprises a power supply indicator sensor.

8. The system according to claim 1, wherein said predetermined parameter determining means comprises a motion sensor.

9. The system according to claim 1, wherein said predetermined parameter determining means comprises electronic tractor identification means.

10. The system according to claim 1, wherein said actuating means comprises a microprocessor.

11. The system according to claim 10, wherein said actuating means further comprises a cellular network.

12. The system according to claim 1, wherein said means for said remote computer to access said predetermined parameters on said host computer comprises a computer network.

13. A method for remotely monitoring predetermined parameters of a vehicle and reporting said predetermined parameters to a host computer that is remote from said vehicle, comprising the steps of:
a. interconnecting a predetermined parameter sensing device to said vehicle; and
b. transmitting signals representative of said predetermined parameters from said predetermined parameter sensing device to said host computer at predetermined intervals.

14. The method according to claim 13, further comprising the step of said host computer storing said received predetermined parameters in a database.

15. The method according to claim 14, further comprising the step of organizing said predetermined parameters in a plurality of tables contained within said database.

16. The method according to claim 15, further comprising the step of permitting said database to be accessed by a remote computer.

17. The method according to claim 16, further comprising the step of permitting said remote computer to query said database.

18. A device adapted for interconnection to a mobile unit and transmitting a plurality of predetermined parameters to a host computer, comprising:
a. a housing;
b. a microprocessor comprising memory and control circuitry and contained within said housing;
c. a plurality of parameter sensors electrically connected to said microprocessor; and
d. means for transmitting said plurality of parameters and said position of said mobile unit to said host computer.

19. The device according to claim 18, wherein said means for transmitting said plurality of parameters and said position of said mobile unit comprises a cellular antenna and receiver.

20. The device according to claim 18, further comprising a global positioning system for determining the position of said mobile unit electrically connected to said microprocessor.

21. The device according to claim 20, wherein said global positioning system comprises a global positioning receiver and antenna.

22. The device according to claim 18, wherein said plurality of parameter sensors comprise a brake detector, a power supply indicating sensor, a motion detector, a tether sensor, and a container sensor.

23. The device according to claim 18, further comprising a power supply.

24. The device according to claim 23, wherein said power supply comprises a battery.
